(19) United States
(12) Patent Application Publication
(10) Pub. No.: US 2007/0248089 A1
(43) Pub. Date: Oct. 25, 2007

(54) SYSTEMS AND METHODS FOR INCORPORATING INFORMATION CORRESPONDING TO AN END-TO-END TRANSMISSION IN DETERMINING ACCESS TO A COMMUNICATION MEDIUM

(76) Inventors: Jason Redi, Belmont, MA (US); Craig Partridge, East Lansing, MI (US)

Correspondence Address: CHOATE, HALL & STEWART LLP, TWO INTERNATIONAL PLACE, BOSTON, MA, 02110, US

(21) Appl. No.: 11/379,294

(22) Filed: Apr. 19, 2006

(51) Int. Cl. H04L 12/56; H04J 3/02

(52) U.S. Cl. 370/392; 370/462

(57) ABSTRACT

Systems and methods for incorporating information corresponding to an end-to-end transmission in determining access to a communication medium include: receiving a first data packet, said first data packet comprising information corresponding to a destination node; determining an intermediate node for said first data packet; and transmitting, to said intermediate node, a request-to-send (RTS) corresponding to said data packet, said RTS comprising information corresponding to said destination node.

### FIELD OF THE INVENTION

The present invention relates to systems and methods for transmitting data over a network. More specifically, the invention relates to incorporating information corresponding to an end-to-end transmission in determining access to a communication medium.

### BACKGROUND OF THE INVENTION

Many networks and network devices provide functionality for transmitting data to an end node where the transmission of data to the end destination requires the data to pass through a number of intermediate nodes. In many cases, said functionality requires devices to know routing information corresponding to other devices on the network. In some cases, the functionality may also allow devices to specify terms of service parameters for data being sent across the network.

Many networks, such as wireless networks, require a number of devices to communicate with each other using a shared medium. In many cases, the shared medium may be limited such that it can only accommodate a given number of simultaneous transmissions. Devices using such a shared medium often implement functionality for allocating access to the medium so as to minimize the amount of data lost due to such network limitations. In many cases, such functionality may be implemented by means of a device sending a request-to-send RTS transmission, which requests use of the shared medium to send data to a given node on the medium. In these cases, a clear-to-send may be used by the target of the RTS to indicate that the RTS was successfully received and the medium is clear for transmission. The node that sent the RTS may then begin transmitting data.

In some cases, inefficiencies may result from the RTS-CTS transmission structure as described. For example, a node A may desire to send data to a destination node Z. The node may consult a routing table and determine that a route exists to Z through node B. The node A may then send an RTS to node B, and receive a CTS indicating the medium is clear. Node A may then begin transmitting the data intended for node Z. Node B then may determine, for a number of reasons, that it cannot pass said data along to node Z. For example, node B may not possess routing information corresponding to node Z, or node B may not have buffer space for the transmission. Although node B may then send an indication to node Z indicating said problems, this structure may result in extra transmissions and greater power consumption. In some cases, node B may have known or been able to determine the inability to transmit to node Z prior to the receipt of said data. Thus there exists a need for incorporating information corresponding to an end-to-end transmission in determining access to a communication medium.

### SUMMARY OF THE INVENTION

In one aspect, the present invention relates to a method for incorporating information corresponding to an end-to-end transmission in determining access to a communication medium. In one embodiment, the method comprises: receiving a first data packet, said first data packet comprising information corresponding to a destination node; determining an intermediate node for said first data packet; and transmitting, to said intermediate node, a request-to-send (RTS) corresponding to said data packet, said RTS comprising information corresponding to said destination node.

In another aspect, the present invention relates to a computer system for incorporating information corresponding to an end-to-end transmission in determining access to a communication medium. In one embodiment, the system comprises: a receiver which receives a first data packet, said first data packet comprising information corresponding to a destination node; a storage element in communication with said receiver which stores said data packet; a processor in communication with said receiver and said storage element which determines an intermediate node for said first data packet; and a transmitter in communication with said processor and said storage element which transmits, to said intermediate node, an RTS corresponding to said data packet, said RTS comprising information corresponding to said destination node.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIGS. 1A and 1B are block diagrams of embodiments of a computing or network device useful as a device in a client-server network;

FIG. 2 is a diagram illustrating one example of a number of computing devices operating in a network;

FIG. 3 is a block diagram depicting one embodiment of a request-to-send (RTS) including information corresponding to an end-to-end transmission;

FIG. 4 is a block diagram depicting one embodiment of a request-to-send (CTS) including information corresponding to an end-to-end transmission;

FIG. 5 is a block diagram depicting one embodiment of a method for incorporating information corresponding to an end-to-end transmission in determining access to a communication medium;

FIG. 6 is a block diagram depicting another embodiment of a method for incorporating information corresponding to an end-to-end transmission in determining access to a communication medium;

FIG. 7 is a block diagram depicting one embodiment a method for incorporating information corresponding to an end-to-end transmission in determining access to a communication medium using a data/acknowledgement framework; and

FIG. 8 is a diagram of an example series of transmissions in which an RTS incorporates an end-to-end destination address.

### Detailed Description of the Invention

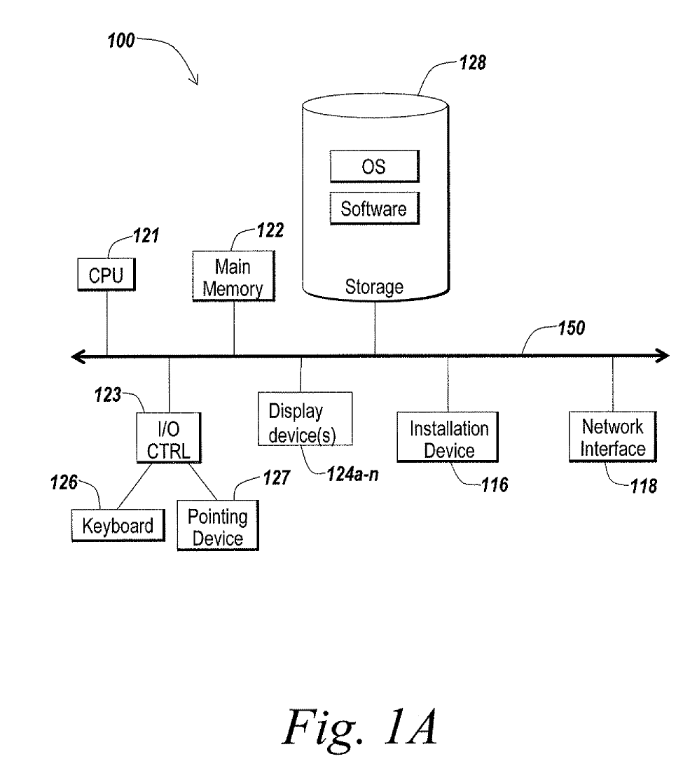

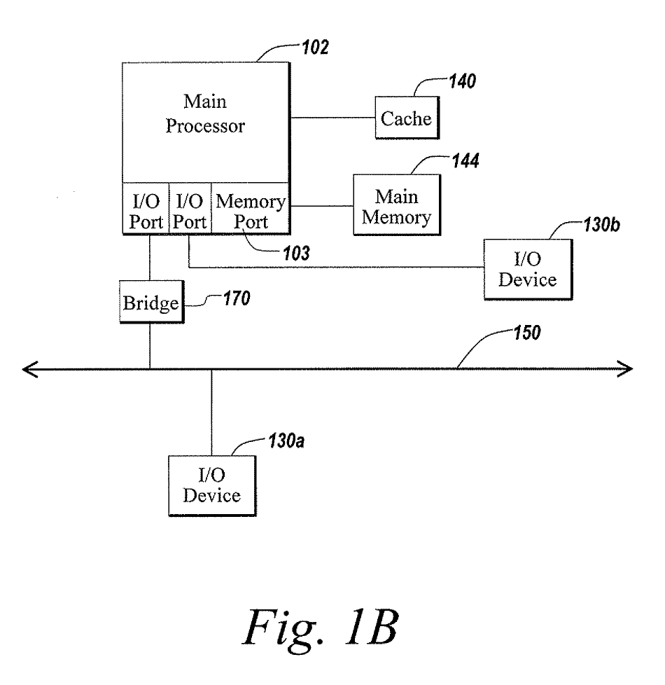

FIGS. 1A and 1B depict block diagrams of a typical computer 100 useful as client computing devices and server computing devices. As shown in FIGS. 1A and 1B, each computer 100 includes a central processing unit 102, and a main memory unit 104. Each computer 100 may also include other optional elements, such as one or more input/output devices 130a-130-b (generally referred to using reference numeral 130), and a cache memory 140 in communication with the central processing unit 102.

The central processing unit 102 is any logic circuitry that responds to and processes instructions fetched from the main memory unit 104. In many embodiments, the central processing unit is provided by a microprocessor unit, such as those manufactured by Intel Corporation of Mountain View, Calif.; those manufactured by Motorola Corporation of Schaumburg, Ill.; the Crusoe and Efficeon lines of processors manufactured by Transmeta Corporation of Santa Clara, Calif.; the lines of processors manufactured by International Business Machines of White Plains, N.Y.; or the lines of processors manufactured by Advanced Micro Devices of Sunnyvale, Calif.

Main memory unit 104 may be one or more memory chips capable of storing data and allowing any storage location to be directly accessed by the microprocessor 102, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). In the embodiment shown in FIG. 1A, the processor 102 communicates with main memory 104 via a system bus 150 (described in more detail below). FIG. 1B depicts an embodiment of a computer system 100 in which the processor communicates directly with main memory 104 via a memory port. For example, in FIG. 1B the main memory 104 may be DRDRAM.

FIGS. 1A and 1B depict embodiments in which the main processor 102 communicates directly with cache memory 140 via a secondary bus, sometimes referred to as a “backside” bus. In other embodiments, the main processor 102 communicates with cache memory 140 using the system bus 150. Cache memory 140 typically has a faster response time than main memory 104 and is typically provided by SRAM, BSRAM, or EDRAM.

In the embodiment shown in FIG. IA, the processor 102 communicates with various IO devices 130 via a local system bus 150. Various busses may be used to connect the central processing unit 102 to the I/O devices 130, including a VESA VL bus, an ISA bus, an EISA bus, a MicroChannel Architecture (MCA) bus, a PCI bus, a PCI-X bus, a PCI-Express bus, or a NuBus, For embodiments in which the I/O device is an video display, the processor 102 may use an Advanced Graphics Port (AGP) to communicate with the display. FIG. 1B depicts an embodiment of a computer system 100 in which the main processor 102 communicates directly with I/O device 130b via HyperTransport, Rapid I/O, or InfiniBand. FIG. 1B also depicts an embodiment in which local busses and direct communication are mixed: the processor 102 communicates with I/O device 130a using a local interconnect bus while communicating with I/O device 130b directly.

A wide variety of I/O devices 130 may be present in the computer system 100. Input devices include keyboards, mice, trackpads, trackballs, microphones, and drawing tablets. Output devices include video displays, speakers, inkjet printers, laser printers, and dye-sublimation printers. An I/O device may also provide mass storage for the computer system 800 such as a hard disk drive, a floppy disk drive for receiving floppy disks such as 3.5-inch, 5.25-inch disks or ZIP disks, a CD-ROM drive, a CD-R/RW drive, a DVD-ROM drive, tape drives of various formats, and USB storage devices such as the USB Flash Drive line of devices manufactured by Twintech Industry, Inc. of Los Alamitos, Calif.

In further embodiments, an I/O device 130 may be a bridge between the system bus 150 and an external communication bus, such as a USH bus, an Apple Desktop Bus, an RS-132 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus. In some embodiments, specialized buses may be used in computing devices adapted for specific purposes. For example, a router may comprise a shared bus or a switched backplane bus.

General-purpose computers of the sort depicted in FIG. 1A and FIG. 1B typically operate under the control of operating systems, which control scheduling of tasks and access to system resources. Typical operating systems include: MICROSOFT WINDOWS, manufactured by Microsoft Corp. of Redmond, Wash.; MacOS, manufactured by Apple Computer of Cupertino, California; OS/2, manufactured by International Business Machines of Armonk, N.Y.; and Linux, a freely-available operating system distributed by Caldera Corp. of Salt Lake City, Utah, among others.

For embodiments comprising mobile devices, the device may be a JAVA-enabled cellular telephone, such as the i55sr, i58sr, i85s, or the i88s, all of which are manufactured by Motorola Corp. of Schaumburg, Ill.; the 6035 or the 7135, manufactured by Kyocera of Kyoto, Japan; or the i300 or i330, manufactured by Samsung Electronics Co., Ltd., of Seoul, Korea. In other embodiments comprising mobile devices, a mobile device may be a personal digital assistant (PDA) operating under control of the PalmOS operating system, such as the Tungsten W, the VII, the VIIx, the i705, all of which are manufactured by palmOne, Inc. of Milpitas, Calif. In further embodiments, the client 113 may be a personal digital assistant (PDA) operating under control of the PocketPC operating system, such as the iPAQ 4155, iPAQ 5555, iPAQ 1945, iPAQ 2215, and iPAQ 4255, all of which manufactured by Hewlett-Packard Corporation of Palo Alto, Calif.; the ViewSonic V36, manufactured by ViewSonic of Walnut, Calif.; or the Toshiba PocketPC e405, manufactured by Toshiba America, Inc. of New York, N.Y.. In still other embodiments, the mobile device is a combination PDA/telephone device such as the Treo 180, Treo 270, Treo 600, Treo 650, Treo 700, or the Treo 700w, all of which are manufactured by palmOne, Inc. of Milpitas, Calif. In still further embodiments, the mobile device is a cellular telephone that operates under control of the PocketPC operating system, such as the MPx200, manufactured by Motorola Corp. A typical mobile device may comprise many of the elements described above in FIGS. 1A and 1B, including the processor 102 and the main memory 104.

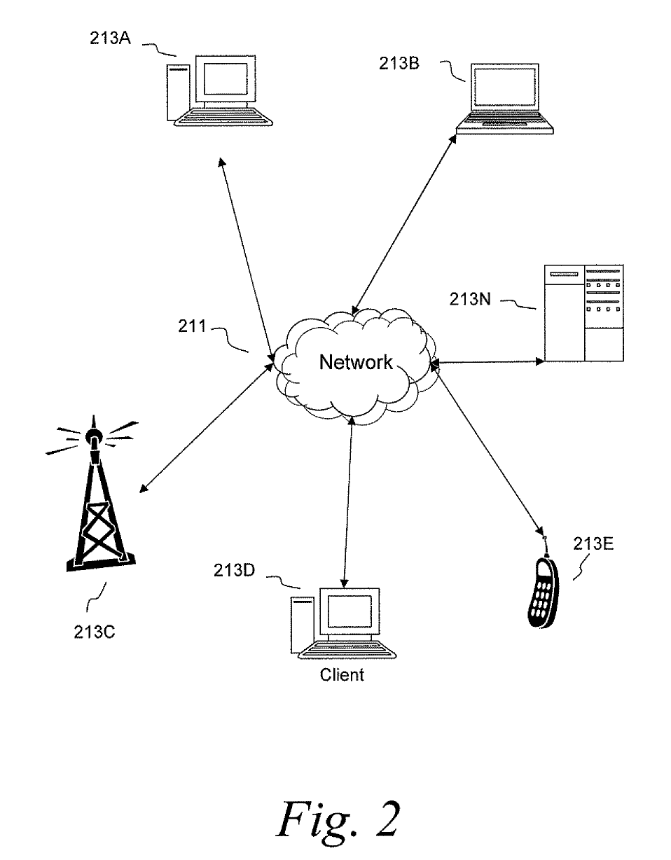

FIG. 2 depicts a block diagram illustrating an embodiment of a number of computing devices operating in a network. In brief overview, a number of devices 21 3A, 213B, . . . 213N (generally referred to as 213), are connected via a network 211. The devices 213, and network 211 may comprise any computing devices comprising substantially similar capabilities, descriptions, functions, and configurations as described herein. Devices connected via a network may also be referred to as nodes.

Still referring to FIG. 2, the network 211 may comprise the any network or number of networks including the Internet, local area networks, metropolitan area networks, and wide area networks. The network 211 may comprise computing devices connected via cables, IR ports, wireless signals, or any other means of connecting multiple computing devices. The network 211 and any devices connected to the networks may communicate via any communication protocol used to communicate among or within computing devices, including without limitation SSL, HTML, XML, RDP, ICA, FTP, HTTP, TCP, IP, UDP, IPX, SPX, NetBIOS, NetBEUI, SMB, SMTP, Ethernet, ARCNET, Fiber Distributed Data Interface (FDDI), RS232, IEEE 802.11, IEEE 802.11a, IEEE 802.11b, IEEE 802.11g and direct asynchronous connections, or any combination thereof. The network 211 may comprise mobile telephone networks utilizing any protocol or protocols used to communicate among mobile devices, including AMPS, TDMA, CDMA, GSM, GPRS or UMTS. The network 211 may comprise a number of physically distinct networks, or the network 211 may comprise a unified network. The network 211 may have any network topology, and any devices 100 or networks within the network 211 may be connected in any manner.

In embodiments comprising a TCP/IP based communications among any of the above devices, any TCP/IP based protocol may be used, including Messaging Application Programming Interface (MAPI) (email), File Transfer Protocol (FTP), HyperText Transfer Protocol (HTTP), Common Internet File System (CIFS) protocol (file transfer), Independent Computing Architecture (ICA) protocol, Remote Desktop Protocol (RDP), Wireless Application Protocol (WAP), Mobile IP protocol, and Voice Over IP (VoIP) protocol. Any type and form of transport control protocol may also be used, such as a modified transport control protocol, for example a Transaction TCP (T/TCP), TCP with selection acknowledgements (TCPSACK), TCP with large windows (TCP-LW), a congestion prediction protocol such as the TCP-Vegas protocol, and a TCP spoofing protocol In other embodiments, any type and form of user datagram protocol (UDP), such as UDP over IP, may be used.

In communicating with devices 100 over a network 211, any of the computing devices 100 described may employ a network stack, which may comprise one or more network layers, such as any networks layers of the Open Systems Interconnection (OSI) communications model as those skilled in the art will recognize and appreciate. The network stack 310 may comprise one or more protocols, such as the TCP/IP protocol over Ethernet or a wireless protocol, such as IEEE 802.11, as those skilled in the art will recognize and appreciate. Furthermore, the network stack 310 may include one or more network drivers supporting the one or more layers, such as a TCP driver or a network layer driver. The network drivers may be included as part of the operating system of the computing device 102 or as part of any network interface cards or other network access components of the computing device 102. Additionally, any of the network drivers of the network stack 310 may be customized, modified or adapted to provide a custom or modified portion of the network stack 310 in support of any of the techniques of the present invention described herein.

In some embodiments, a network stack may comprise a layer for managing device-to-device transmissions. This layer may comprise the data link layer, as it is understood by those skilled in the art with respect to the OSI communications model discussed above. Said layer may provide functionality for operating a communication link between two devices on a network. In one embodiment, said layer may comprise a media access control (MAC) layer, as it is understood by those skilled in the art. Examples of MAC protocols may include CSMA and CSMA/CA. Said layer may provide functionality for negotiating access to a shared physical medium. For example, in a wireless network, a MAC layer may provide functionality for determining whether a given device is clear to transmit over a shared frequency. Or for example, in a wireless network, a MAC layer may provide functionality for determining whether data transmitted over said shared frequency was successfully received. Or for example, in a wired network, a MAC layer protocol, such as DQDB as specified in IEEE 802.6 may be used to specify a bid/reply framework for determining access to to a shared wire or resource.

In other embodiments, a network stack may comprise a layer for managing end-to-end transmissions. Said end-to-end layer may provide functionality for transmitting data from one device to another device across a series of communication links and other devices. For example, in a wireless network, an end-to-end layer may provide functionality such that a device A can transmit data to device Z, even though device Z is not directly connected to A. In some embodiments, an end-to-end layer may provide functionality for specifying terms of service. For example, an end-to-end layer may provide functionality for specifying a given maximum latency for the end-to-end transmission. Examples of end-to-end protocols may include TCP and IP.

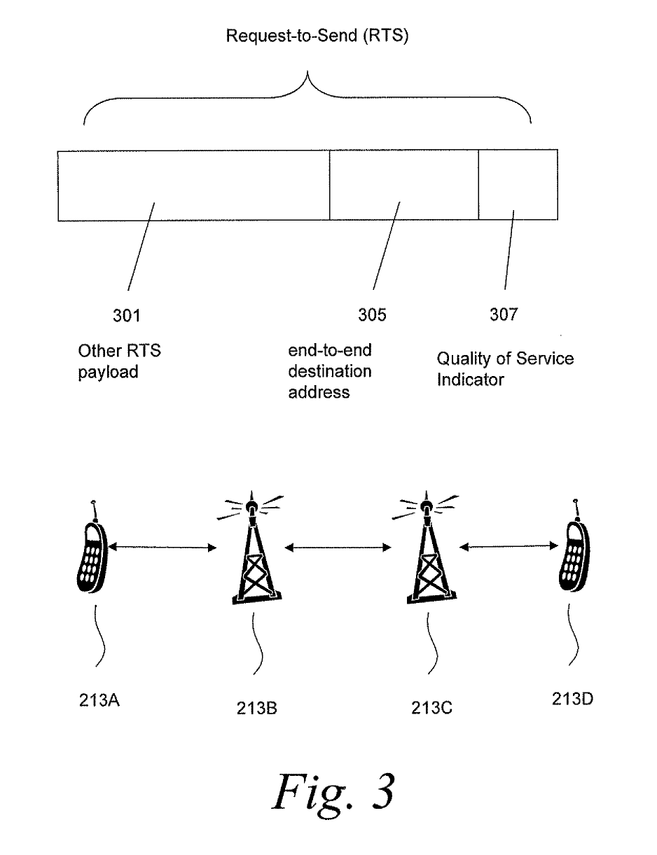

Referring now to FIG. 3, a block diagram depicting one embodiment of a request-to-send (RTS) including information corresponding to an end-to-end transmission is shown. In brief overview, an RTS comprises fields for an RTS payload 301, in addition to fields a destination address 305, and terms of service 307. In addition, an example of a network comprising four nodes 213A, 213B, 213C, and 213D in which an RTS may be employed is shown.

Still referring to FIG. 3, now in greater detail, an RTS may be used to request clearance to transmit data between two devices over a given medium. Said RTS may be transmitted over any of the networks discussed herein. Said RTS may be used to determine whether the communication medium is currently available for the transmission of data. For example, in a wireless network, an RTS may be used to determine whether a given frequency is currently clear for transmitting. Or for example, in a wireless network, an RTS may be used to determine whether a given node is already receiving data from another source. In some embodiments, an RTS may be used as part of a MAC layer protocol. In the embodiment shown, the RTS may comprise any protocol or custom to identify and encode the RTS payload 301, the end-to-end destination 305, and the terms of service 307.

In some embodiments, an RTS may correspond to a request to send a single data packet or transmission. In other embodiments, an RTS may correspond to a request to send a plurality of data packets or transmissions. In some embodiments, an RTS may correspond to a request to send a data packet to a single node. In other embodiments, an RTS may correspond to a request to send a data packet to a plurality of nodes. In some embodiments, a single RTS may have many fields corresponding to end-to-end addresses 305. In other embodiments, a single RTS may have many fields corresponding to terms of service 307.

In the embodiment shown, an RTS comprises a field for an RTS payload 301. Said payload 301 may comprise any information or data used in any known RTS protocol or MAC layer protocol. In some embodiments, said payload 301 may comprise an address of the device transmitting the RTS. In some embodiments, said payload 301 may comprise an address of the device intended as the recipient for the RTS. In other embodiments, said RTS may comprise a timestamp. In some embodiments, the RTS payload 301 may comprise a special sequence, code, or portion of a transmission frame which designates that the transmission is an RTS. In some embodiments, the RTS payload 301 may comprise information corresponding to the length of the data packet to be transmitted.

In the embodiment shown, an RTS comprises a field corresponding to the end-to-end destination address 305. Said end-to-end destination address 305 may correspond to the final destination for the data associated with said RTS. For example, a node 213A may desire to send data to a node 213D. If no direct connection exists between the nodes, node 213A may transmit said data to node 213B such that node 213B could then forward the data such that it eventually was received by node 213D. In one embodiment, node 213A may transmit an RTS to node 213B prior to sending said data. Said RTS may indicate the end-to-end destination address (node 213D) in addition to a source address (node 213A) and an RTS destination address (node 213B). In some embodiments, an RTS may comprise a plurality of end-to-end destination addresses.

In some embodiments, said end-to-end address may correspond to an IP address, including without limitation IPv4 and IPv6. In some embodiments, said end-to-end address may comprise all of a given address. In other embodiments, said end-to-end address may comprise a portion of a given address. For example, said end-to-end address may comprise a subnet address of a given node. Or for example, said end-to-end address may comprise a host address of a given node.

In the embodiment shown, an RTS may also comprise a field corresponding to terms of service 307. Said terms of service may comprise any terms relating to any aspect of network service or data delivery, including without limitation latency, bandwidth, error-rate, dropped packet rate, ordering. In some embodiments, said terms of service may be specified in an end-to-end layer protocol. In other embodiments, said terms of service may be specified in any other layer of the network stack as discussed herein. For example, a node 213A may desire to send data to a node 213D with a maximum latency of 100 milliseconds. If no direct connection exists between the nodes, node 213A may transmit said data to node 213B such that node 213B could then forward the data such that it eventually was received by node 213D. In one embodiment, node 213A may transmit an RTS to node 213B prior to sending said data. Said RTS may indicate the end-to-end destination address (node 213D) a terms of service (here, maximum latency 100 ms) in addition to a source address (node 213A) and an RTS destination address (node 213B).

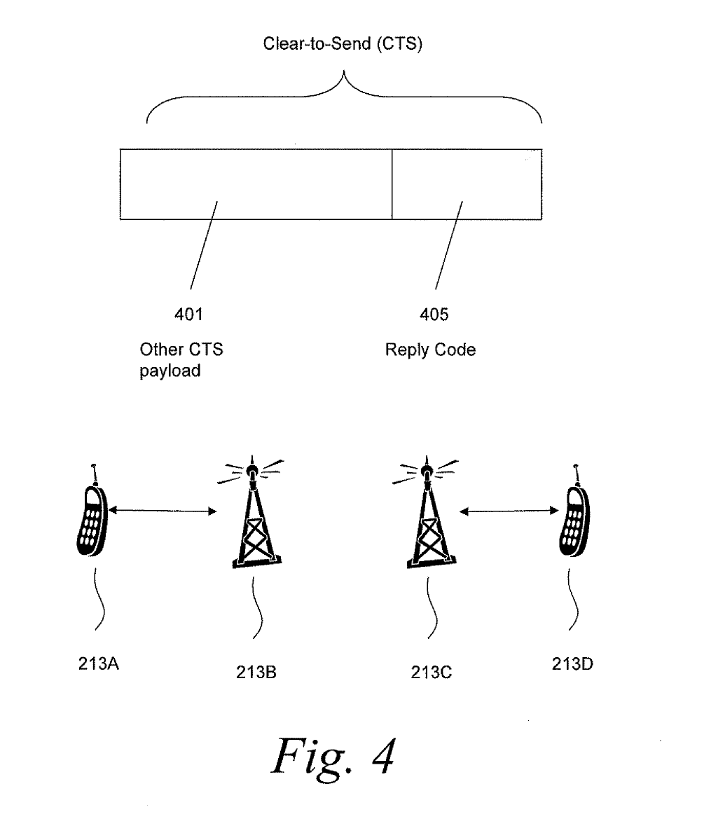

Referring now to FIG. 4, a block diagram depicting one embodiment of a request-to-send (CTS) including information corresponding to an end-to-end transmission is shown. In brief overview, a CTS comprises a CTS payload 401 and a reply code 405. In addition, an example of a network comprising four nodes 213A, 213B, 213C, and 213D in which a CTS may be employed is shown.

Still referring to FIG. 4, now in greater detail, a CTS may be used to indicate clearance to transmit data between two devices over a given medium. Said CTS may be transmitted over any of the networks discussed herein. Said CTS may be used in conjunction with an RTS to indicate whether the communication medium is currently available for the transmission of data. For example, in a wireless network, an CTS may be used to indicate whether a given frequency is currently clear for transmitting. For example, if a node 213B receives an RTS from node 231A, node 213B may respond with a CTS indicating that the frequency is clear for transmitting. Node 213A may then begin transmitting data. If node 213A does not receive a CTS, node 213A may infer that the medium is currently in use, and attempt to send another RTS at a later time. In the embodiment shown, the CTS may comprise any protocol or custom to identify and encode the CTS payload 301, the end-to-end destination 305, and the terms of service 307.

In some embodiments, a CTS may correspond to a single data packet or transmission. In other embodiments, a CTS may correspond to a plurality of data packets or transmissions. In some embodiments, an RTS may correspond to a request to send a data packet to a single node. In other embodiments, an RTS may correspond to a request to send a data packet to a plurality of nodes. In some embodiments, a single CTS may have a plurality of fields corresponding to reply codes 405.

In the embodiment shown, a CTS comprises a CTS payload 401 Said payload 401 may comprise any information or data used in any known CTS protocol or MAC layer protocol. In some embodiments, said payload 401 may comprise an address of the device transmitting the CTS. In some embodiments, said payload 401 may comprise an 12 address of the device intended as the recipient for the CTS. In other embodiments, said CTS may comprise a timestamp. In some embodiments, the CTS payload 401 may comprise a special sequence or code which designates that the transmission is a CTS.

In the embodiment shown, a CTS comprises a reply code 405, In some embodiments, said reply code 405 may be used to indicate circumstances in which the communication medium is clear for transmission but other reasons exist for why data should not be sent. Said reply code 405 may be encoded in any manner, including as an integer, character, or frequency. In some embodiments, the reply code 405 may comprise a code indicating that transmission is clear and data should be sent.

In some embodiments, the reply code 405 may comprise a refusal to accept a given transmission. In one embodiment, the reply code 405 may indicate that the node transmitting the CTS has no known route to an end-to-end destination node specified in an RTS. In another embodiment, the reply code 405 may indicate that the node transmitting the CTS has no known route to an end-to-end destination node specified in an RTS, but indicate that a route to the end-to-end destination previously existed through a given node. In another embodiment, the reply code 405 may indicate that the node transmitting the CTS cannot meet the terms of service specified in an RTS. In still another embodiment, the reply code 405 may indicate that the node transmitting the CTS cannot accept transmission due to network traffic shaping rules. In other embodiments, the reply code 405 may indicate any other reasons for refusing to accept transmission, including without limitation network failures, power constraints, and security constraints.

In some embodiments, the reply code may comprise a refusal to accept a data packet at a given time, and comprise information that said intermediate node may be able to accept the packet at a later time. For example, a reply code may indicate that said intermediate node currently has no buffer space for said transmission, but buffer space may become available later. Or, for example, a reply code may indicate that said intermediate node is currently waiting for a transmission from another source. In some embodiments, the reply code may indicate a specific time interval corresponding to an anticipated time the intermediate node may be able to receive said packet.

For example, in the network shown, node 213A may desire to send a data packet to node 213D. Node 213A may send an RTS to node 213B indicating the destination node of 213D. Node 213B may transmit a CTS to node 213A indicating that the medium is clear for transmission, but that node 213B currently has no known route to node 213D.

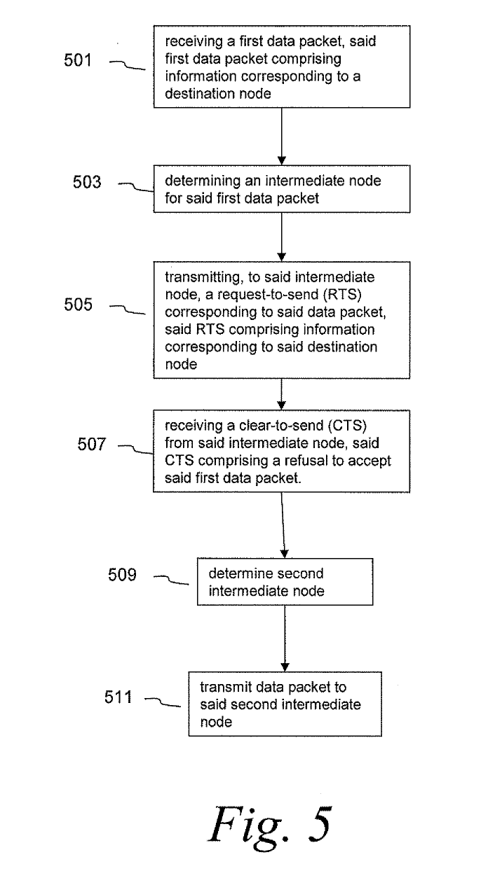

Referring now to FIG. 5, one embodiment of a method for incorporating information corresponding to an end-to-end transmission in determining access to a communication medium is shown. In brief overview, said method comprises: receiving a first data packet, said first data packet comprising information corresponding to a destination node (step 501); determining an intermediate node for said first data packet (step 503); transmitting a request-to-send (RTS) to said intermediate node, said RTS comprising information corresponding to said data packet and said destination node (step 505); receiving a clear-to-send (CTS) from said intermediate node, said CTS comprising a refusal to accept said first data packet (step 507); determining a second intermediate node for said first data packet (step 509); and transmitting said second data packet to said second intermediate node (step 511). Said method may be performed by any computing device described herein. In the following description, said method will be described in the context of being performed on a node 213 of a network 211.

Still referring to FIG. 5, now in greater detail, a node 213 may receive a first data packet, said first data packet comprising information corresponding to a destination node (step 501). Said first data packet may comprise any data packet comprising data, and may correspond to any of the protocols described herein. In some embodiments, the packet may be received from an application executing on the node 213. In some embodiments, the packet may be received from a layer of a network stack. In some embodiments, the packet may be received from another node 213. Said packet may be received by any means of data transmission. In some embodiments, said data packet may corresponding to a data packet in an end-to-end protocol layer.

Said first data packet may comprise information corresponding to a destination node. Said information may comprise an address corresponding to the destination of the data packet. Said destination node may be specified according to any protocol described herein. In some embodiments, said destination address may correspond to an IP address of the destination for said data packet. In other embodiments, said destination address may correspond to an address specified in any end-to-end protocol.

After receiving said first data packet (step 501), a node 213 may determine an intermediate node for said first data packet (step 503). Said intermediate node may correspond to any of the computing devices described herein.

A node 213 may determine an intermediate node according to any method for determining intermediate nodes in a transmission path. In some embodiments, the intermediate node may be determined by referencing a routing table. In other embodiments, the intermediate node may be determined by determining the node in closest proximity to the determining node 213. In still other embodiments, the intermediate node may be determined by selecting any node which the determining node 213 possesses a communication link with.

After determining an intermediate node (step 503), a node 213 may transmitting, to said intermediate node, an RTS corresponding to said data packet, said RTS comprising information corresponding to said destination node (step 505). Said RTS may comprise any RTS as described herein, and may be transmitted via any of the methods and protocols described herein. In some embodiments, transmitting said RTS to said intermediate node may comprise transmitting an RTS comprising a network address of said intermediate node. In one embodiment, said RTS may be transmitted using a MAC layer protocol.

In some embodiments, the node 213 may delay transmission of said first data packet until receipt of a CTS corresponding to said RTS. In other embodiments the node 213 may transmit some or all of said first data packet without waiting for receipt of a CTS. In still other embodiments, some of all of said first data packet may be included in the RTS.

After transmitting said RTS (step 505), a node 213 may receive a clear-to-send (CTS) from said intermediate node, said CTS comprising a refusal to accept said first data packet (step 507). Said CTS may comprise any CTS as described herein, and said CTS may be received via any of the methods and protocols described herein. In one embodiment, said CTS may be received via a MAC layer protocol. In some embodiments, the node 213 may determine that the CTS comprises a refusal by processing a reply code 405 contained in said CTS. A refusal to accept said first data packet may comprise any reason for rejecting transmission of a data packet as described herein, including without limitation a lack of routing information, and traffic shaping rules.

In some embodiments the node 213 may transmit said data packet to said intermediate node despite said refusal. In other embodiments, the node 213 may transmit a second RTS to said intermediate node. In some embodiments, the node 213 may wait a given amount of time before transmitting a second RTS to said intermediate node. For example, the node 213 may receive a CTS comprising a reply code indicating that the intermediate node's buffers are currently full, but that they may become clear at a later time. The node 213 may then wait a given time interval, and then transmit a second RTS.

After receiving said CTS (step 507), a node 213 may determine a second intermediate node for said first data packet (step 509). A node 213 may determine a second intermediate node for said first data packet by using any means for determining an intermediate node discussed herein. In some embodiments, said determination may be made in an end-to-end layer protocol layer.

In some embodiments, a node 213 may determine a second intermediate node (step 509) by using a node indicated in said CTS. For example, a CTS may indicate thatthe node transmitting the CTS has no known route to the destination node specified in the RTS, but indicate that a route to the end-to-end destination previously existed through a given node. The node 213 may then designate said given node as the second intermediate node.

In some embodiments, a node 213 may determine a second intermediate node (step 509) by determining a source route to said destination node. Said source route may be determined using any known method for determining a source route.

In some embodiments, a node 213 may determine a second intermediate node based on the type of refusal received in a CTS. For example, a node 213 may receive a CTS indicating that said intermediate node does not possess routing information relating to the destination node. Said lack of routing information may indicate that the routing tables at a number of nodes in the network are inconsistent. The node 213 may then select a second intermediate node corresponding to a route designed to avoid said inconsistencies in the routing tables. In some embodiments, a source route may be determined which avoids the first intermediate node by a given radius of nodes, with the radius determined by the estimated severity of the routing problem. Or, for example, a node 213 may receive a CTS indicating that said intermediate node cannot accept the first data packet because of traffic shaping concerns. The node 213 may then select a second intermediate node corresponding to a node which may be consistent with traffic shaping rules. In some embodiments, a source route may be determined which avoids the first intermediate node by a given radius of nodes, with the radius determined by the nature of the traffic shaping rules.

In some embodiments, a second intermediate node may be determined by determining a node X where X is a node which lies on a known path to the source of said first data packet, and where node X does not list the first intermediate node as a next hop for transmitting a packet to the destination node. In some embodiments, the second intermediate node may be directly connected to the node 213. In other embodiments, the second intermediate node may not be directly connected to the node 213.

After determining a second intermediate node for said first data packet (step 509), the node 213 may then transmit said data packet to said second intermediate node (step 511). Said transmission may occur via any of the protocols or methods described herein. In some embodiments, the node 213 may send an RTS to said second intermediate node according to any of the embodiments described herein.

In some embodiments, the node 213 may encapsulate said first data packet prior to transmission. Said packet encapsulation may comprise including said first data packet in the payload of a second data packet. Said second data packet may comprise a flag or other indicator that it contains an encapsulated packet. The node 213 may then set the address of said second data packet to the address of the second intermediate node. The node 213 may then transmit said second data packet according to any protocol or method described herein. For example, a node 213 may encapsulate said first data packet in an IP or other end-to-end layer protocol packet addressed to said second intermediate node.

In other embodiments, the node 213 may transmit said data packet to said second intermediate node (step 511) by using a source route. A source route may be determined using any known method, and may be implemented in the transmission using any known technique.

In still other embodiments, the node 213 may use both encapsulation and source routing in transmitting the packet to said second intermediate node. For example, after determining that an inconsistency may exist, a node 213 may encapsulate said first data packet in a second data packet. The node 213 may then determine a second intermediate node and a source route to said second intermediate node. The node 213 may then transmit the second data packet using said source route.

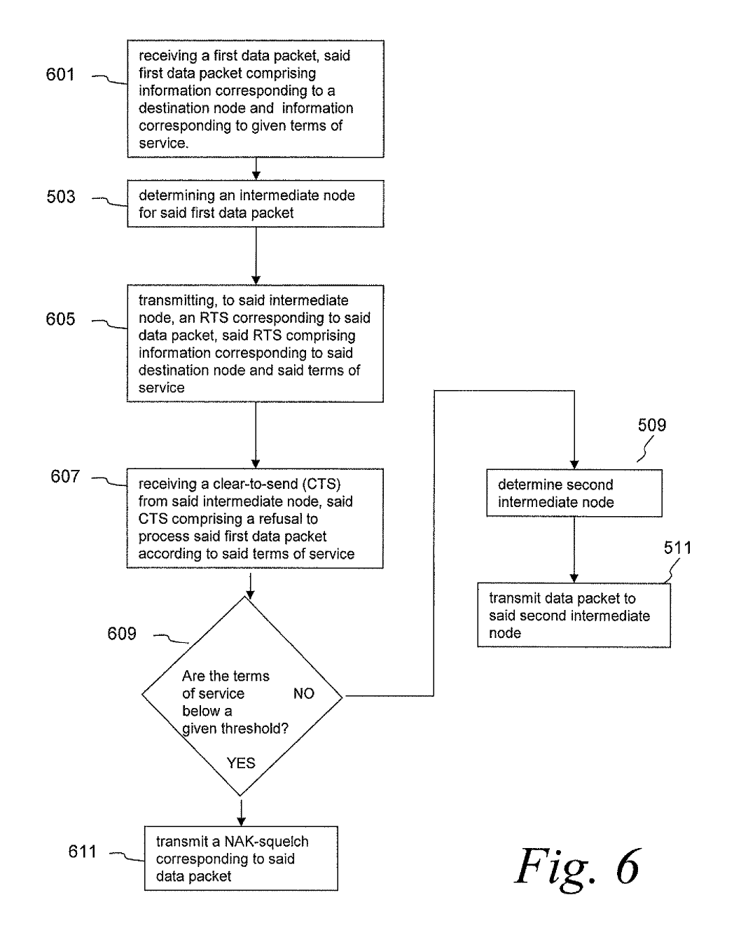

Referring now to FIG. 6, another embodiment of a method for incorporating information corresponding to an end-to-end transmission in determining access to a communication medium is shown. In brief overview, said method comprises: receiving a data packet, said data packet comprising information corresponding to a destination node and information corresponding to given terms of service (step 601); determining an intermediate node for said first data packet (step 603); transmitting, to said intermediate node, an RTS corresponding to said data packet, said RTS comprising information corresponding to said destination node and said terms of service (step 605); and receiving a CTS from said intermediate node, said CTS comprising a refusal to accept said first data packet (step 607). The method may then comprise determining whether the terms of service are below a given threshold (step 609), and either transmitting a negative acknowledgement squelch (NAK-squelch) (step 611); or determining a second intermediate node for said first data packet (step 613); and transmitting said second data packet to said second intermediate node (step 615). Said method may be performed by any computing device described herein. In the following description, said method will be described in the context of being performed on a node 213 of a network 211.

Still referring to FIG. 6, now in greater detail, a node 213 may receive a first data packet, said first data packet comprising information corresponding to a destination node and information corresponding to given terms of service (step 601), Said first data packet may comprise any data packet described herein, and be received according to any of the methods described herein. The information corresponding to given terms of service may comprise information corresponding to any terms of service described herein. In some embodiments, said terms of service may comprise terms of service from and end-to-end layer.

After receiving said first data packet (step 601), a node 213 may determine an intermediate node for said first data packet (step 503). This step may be performed in accordance with any of the methods described herein.

After determining an intermediate node for said first data packet (step 503); a node 213 may transmit, to said intermediate node, an RTS corresponding to said data packet, said RTS comprising information corresponding to said destination node and said terms of service (step 605). Said RTS may be comprise any RTS as described herein, and may be transmitted according to any of the methods described herein.

After transmitting the RTS (step 605), a node 213 may receive a clear-to-send (CTS) from said intermediate node, said CTS comprising a refusal to accept said first data packet according to said terms of service (step 607). Said CTS may comprise any CTS described herein, and be received in any manner described herein. The refusal to accept said data packet according to the terms of service may comprise any inability to meet any of the terms of service. For example, the intermediate node may not have buffer space for said data packet. Or for example, the intermediate node may not have a route to the destination node that satisfies a given latency requirement. In some embodiments, a CTS may comprise information relating to the reason the intermediate node cannot meet the given terms of service, which may comprise any reason described herein.

After receiving said CTS (step 607), a node 213 may determine whether the terms of service are below a given threshold (step 609). Said threshold may relate to any property of terms of service described herein, including without limitation, latency, error-rate, and ordering. In some embodiments, said determination may comprise a determination that it is impossible to meet said terms of service given the refusal of the intermediate node to accept the packet. In other embodiments, said determination may comprise a determination that meeting said terms of service is unlikely given the refusal of the intermediate node to accept the packet. In still other embodiments, said determination may comprise a determination that said packet is inessential and may be dropped.

If the node 213 determines that said terms of service are below a given threshold, the node 213 may then transmit a NAK-squelch corresponding to said packet. Said NAK-squelch may comprise a notification to the source of said first data packet to discontinue transmitting packets to the destination node according to the terms of service. The NAK-squelch may be transmitted according to any protocol or method described herein. In some embodiments, said NAK-squelch may be transmitted to a network stack layer or application executing on the node 213. In other embodiments, said NAK-squelch may be transmitted to another node using an end-to-end protocol layer.

If the node 213 determines that said terms of service are not below a given threshold, the node 213 may then determine a second intermediate node (step 511). This step may be performed in accordance with any of the methods described herein. In some embodiments, a node 213 may determine a second intermediate node based on the type of refusal received in a CTS. For example, a node 213 may receive a CTS indicating that said intermediate node could not accept the first data packet due to a lack of buffer space. The node 213 may then determine that congestion in a particular area of the network is likely. The node 213 may then select a second intermediate node corresponding to a route designed to avoid said network congestion. In some embodiments, a source route may be determined which avoids the first intermediate node by a given radius of nodes, with the radius determined by the estimated severity of the congestion.

After determining a second intermediate node for said first data packet (step 509), the node 213 may then transmit said data packet to said second intermediate node (step 511). This step may be performed in accordance with any of the embodiments described herein.

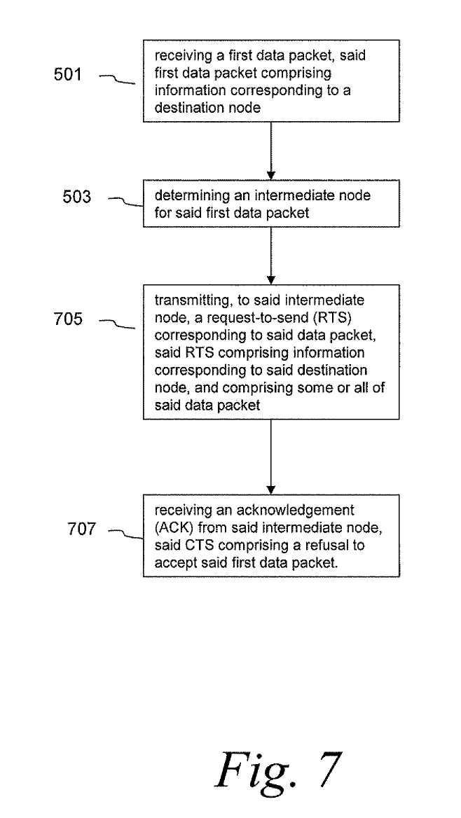

Referring now to FIG. 7, an embodiment of a method for incorporating information corresponding to an end-to-end transmission in determining access to a communication medium using a data/acknowledgement framework is shown. In brief overview the method comprises: receiving a first data packet, said first data packet comprising information corresponding to a destination node (step 501); determining an intermediate node for said first data packet (step 503); transmitting, to said intermediate node, an RTS corresponding to said data packet, said RTS comprising information corresponding to said destination node and comprising data from said data packet (step 705); and receiving an acknowledgement (ACK) from said intermediate node, said ACK comprising a refusal to accept said first data packet (step 707). Said method may be performed by any computing device described herein. In the following description, said method will be described in the context of being performed on a node 213 of a network 211.

Still referring to FIG. 7, a node 213 receives a first data packet, said first data packet comprising information corresponding to a destination node (step 501). This step may be performed according to any embodiment described herein.

After receiving said first data packet (step 501), a node 213 may determine an intermediate node for said first data packet (step 503). This step may be performed in accordance with any of the embodiments described herein.

After determining an intermediate node for said first data packet (step 503); a node 213 may transmit, to said intermediate node, an RTS corresponding to said data packet, said RTS comprising information corresponding to said destination node and comprising data from said data packet (step 705). This step may be performed in accordance with any of the embodiments described herein. In some embodiments, a fixed number of bytes of the first data packet may be included in the RTS. In other embodiments, the number of bytes of said data packet included in said RTS may vary.

In some embodiments, an RTS may be an implied RTS. For example, a device on a shared network may assume that the network is clear and begin sending data without a prior RTS. In these embodiments, the transmitted data may act as an RTS. In some embodiments, the data may be sent using a link layer protocol. In some embodiments, collision detection mechanisms may be used in conjunction with said transmission methods. In other embodiments, collision avoidance mechanisms may be used in conjunction with the transmission methods.

In some embodiments, a node 213 may transmit, to said intermediate node via a data link layer protocol, a portion of said first data packet and information corresponding to said destination node. In another embodiment, a node 213 may transmit, to said intermediate node via a data link layer protocol, the entirety of said first data packet and information corresponding to said destination node. In these embodiments, the information corresponding to the destination node may comprise any information corresponding to a destination node as described herein, including without limitation a network address or an IP address. Said information may be encoded in any manner described herein.

After transmitting the RTS (Step 705), the node 213 may receive an acknowledgement (ACK) from said intermediate node, said ACK comprising a refusal to accept said first data packet (step 707). Said ACK may be received via any of the methods or protocols described herein. In one embodiment, said ACK may corresponding to a MAC layer protocol. Said ACK may indicate that the RTS and accompanying data was successfully received by the intermediate node, but also indicate a refusal to process said data. In one embodiment, said refusal may be indicated by a reply code 405 as described herein. Said refusal may be for any of the reasons described herein, including without limitation lack of routing information, insufficient buffer space, inability to meet terms of service, and traffic shaping rules.

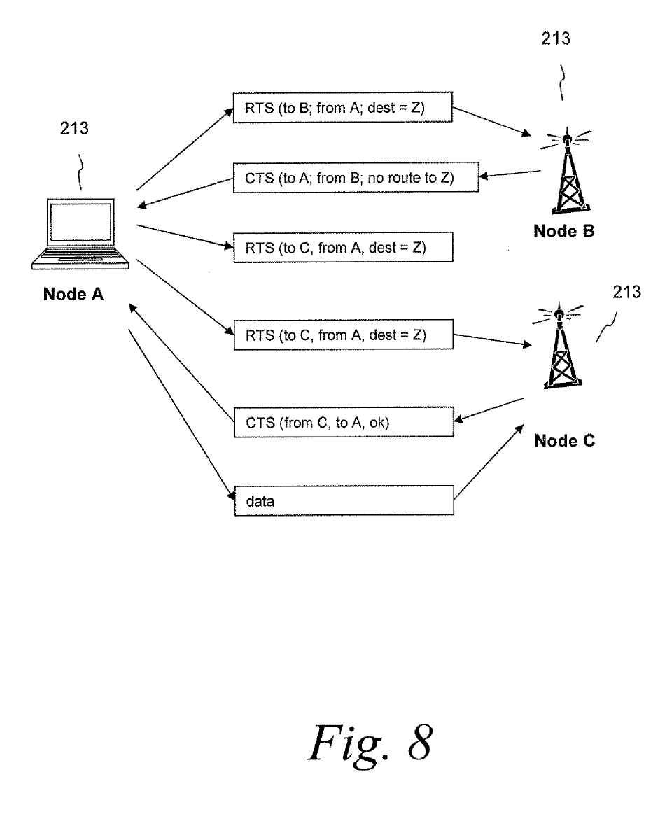

Referring now to FIG. 8, an example series of transmissions in which an RTS incorporates an end-to-end destination address is shown. In brief overview, the series of transmissions illustrates one embodiment of method in which node A is attempting to send a packet with an end-to-end destination of node Z.

Still referring to FIG. 8, now in greater detail, a node A transmits a first RTS to node B. The RTS identifies node B as the target of the RTS, node A as the source of the RTS, and node Z as the end-to-end destination of the data packet to be sent. In some embodiments, the RTS may comprise any other information as described herein. In some embodiments, node A may send said first RTS after receiving a data packet (step 501), and determining a first intermediate node (step 503) described herein.

After node A transmits the first RTS, node B transmits a CTS in response. Said CTS indicates that node B successfully received the first RTS, and that the medium is clear to send a data packet. The CTS also indicates that node B does not possess routing information corresponding to node Z. Node B may make the determination that it does not possess routing information corresponding to node Z using any known method of network routing. In some embodiments, node B may consult a routing table to make the determination. In other embodiments, node B may use a forwarding module to make the determination.

After node A receives the CTS (step 507), node A may then determine a second intermediate node (step 509) as described herein. Node A then transmits an RTS (step 505) to node C. The RTS identifies node C as the target of the RTS, node A as the source of the RTS, and node Z as the end-to-end destination of the data packet to be sent.

Node A then receives no response to said RTS. The lack of response may indicate that the transmission medium is currently in use, that node C is currently receiving another transmission, or any other failure.

Node A then may transmit a third RTS (step 505), attempting again to reach node C. The RTS identifies node C as the target of the RTS, node A as the source of the RTS, and node Z as the end-to-end destination of the data packet to be sent. In other embodiments, node A make take any other action with respect to a failure to receive a CTS corresponding to a MAC layer protocol.

After node A transmits the third RTS, node C transmits a CTS in response. Said CTS indicates that node C successfully received an RTS, and that the medium is clear to send a data packet. The CTS also may indicate that node C possesses routing information corresponding to node Z. Node C may make the determination that it does possess routing information corresponding to node Z using any method described herein.

After node A receives the CTS (step 507), node A may then transmit some or all of the data intended for node Z to node C. Said transmission may be performed according to any of the methods described herein.

In some embodiments, the method described herein may be performed by any number of nodes 213 in a network 211. In some embodiments, only wireless nodes in a network may perform the methods described in FIGS. 3-8, while other nodes in the network may transmit data according to other protocols and methods, In other embodiments, only nodes with given power usage requirements may perform the methods described in FIGS. 3-8, while other nodes in the network may transmit data according to other protocols and methods. In still other embodiments, only nodes in a network with a certain amount of mobility may perform the methods described in FIGS. 3-8, while other nodes in the network may transmit data according to other protocols and methods.

While various embodiments of the present invention have been described above, it should be understood that they have been presented by way of example only, and not limitation. Thus, it will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

We claim:

1. A method for incorporating information corresponding to an end-to-end transmission in determining access to a communication medium, said method comprising:
(a) receiving a first data packet, said first data packet comprising information corresponding to a destination node;
(b) determining an intermediate node for said first data packet;
(c) transmitting, to said intermediate node, a request-to-send (RTS) corresponding to said data packet, said RTS comprising information corresponding to said destination node.

2. The method of claim 1, wherein step (c) comprises transmitting a request-to-send (RTS) to said intermediate node, said RTS corresponding to a plurality of data packets.

3. The method of claim 1, further comprising the step of transmitting said data packet to said intermediate node.

4. The method of claim 1, further comprising the step of:
(d) receiving a transmission from said intermediate node, said transmission comprising a refusal to accept said first data packet.

5. The method of claim 4 wherein step (d) comprises receiving a clear-to-send (CTS) from said intermediate node, said CTS comprising a refusal to accept said first data packet.

6. The method of claim 4 wherein step (d) comprises receiving, via a MAC-layer protocol, a transmission from said intermediate node, said transmission comprising a refusal to accept said first data packet.

7. The method of claim 4 wherein step (d) comprises receiving an acknowledgement (ACK) from said intermediate node, said ACK comprising a refusal to accept said first data packet.

8. The method of claim 4, wherein step (d) comprises receiving a clear-to-send (CTS) from said intermediate node, said CTS comprising a refusal to accept a plurality of said data packets.

9. The method of claim 4, further comprising the step of delaying transmission of said first data packet until receipt of said CTS.

10. The method of claim 4 wherein step (d) comprises receiving a transmission from said intermediate node, said transmission comprising information that said intermediate node does not possess routing information corresponding to said destination node.

11. The method of claim 4 wherein step (d) comprises receiving a transmission from said intermediate node, said transmission comprising information that said intermediate node cannot accept the packet due to traffic shaping rules.

12. The method of claim 4 wherein step (d) comprises receiving a transmission from said intermediate node, said transmission comprising a refusal to accept said first data packet, and comprising information that said intermediate node may be able to accept the packet at a later time.

13. The method of claim 12 further comprising the steps of:
(i) waiting for a given period of time; and
(ii) transmitting, to said intermediate node, a second RTS corresponding to said data packet.

14. The method of claim 4, further comprising the steps of:
(i) determining a second intermediate node for said first data packet,
(ii) encapsulating said first data packet within a second data packet, said second data packet comprising a destination address of said second intermediate node, and
(iii) transmitting said second data packet.

15. The method of claim 4, further comprising the steps of:
(i) determining a source route corresponding to said destination node, said source route not comprising said intermediate node,
(ii) transmitting a second data packet comprising said data packet and said source route.

16. The method of claim 1, wherein step (a) comprises receiving a first data packet, said first data packet comprising information corresponding to a destination node and information corresponding to given terms of service.

17. The method of claim 16, further comprising the steps of:
(i) determining said terms of service are below a given threshold;
(ii) transmitting a negative acknowledgement squelch (NAK-squelch) corresponding to said data packet.

18. The method of claim 16, wherein step (c) comprises transmitting an RTS to said intermediate node, said RTS corresponding to said first data packet, and said RTS comprising information corresponding to said destination node and said terms of service.

19. The method of claim 18, wherein step (d) comprises receiving a transmission from said intermediate node, said transmission comprising a refusal to process said first data packet according to said terms of service.

20. A method for incorporating information corresponding to an end-to-end transmission in a data link layer protocol, said method comprising:
(a) receiving a first data packet, said first data packet comprising information corresponding to a destination node;
(b) determining an intermediate node for said first data packet;
(c) transmitting, to said intermediate node via a data link layer protocol, a portion of said first data packet and information corresponding to said destination node.

21. The method of claim 20, wherein step (c) comprises transmitting, to said intermediate node via a data link layer protocol, the entirety of said first data packet and information corresponding to said destination node.

22. The method of claim 20, further comprising the step of receiving an acknowledgement (ACK), said ACK comprising a refusal to accept said first data packet.

23. The method of claim 20, further comprising the step of receiving an acknowledgement from said second intermediate node, said ACK comprising information that said intermediate node does not possess routing information corresponding to said destination node.

24. A computer system for incorporating information corresponding to an end-to-end transmission in determining access to a communication medium, said system comprising:
a receiver which receives a first data packet, said first data packet comprising information corresponding to a destination node;
a storage element in communication with said receiver which stores said data packet;
a processor in communication with said receiver and said storage element which determines an intermediate node for said first data packet; and
a transmitter in communication with said processor and said storage element which transmits, to said intermediate node, a request-to-send (RTS) corresponding to said data packet, said RTS comprising information corresponding to said destination node.

25. The system of claim 24, wherein the transmitter transmits a request-to-send (RTS) to said intermediate node, said RTS comprising information corresponding to a plurality of data packets.

26. The system of claim 24, wherein the transmitter transmits said data packet to saidintermediate node.

27. The system of claim 24, wherein the receiver receives a transmission from said intermediate node, said transmission comprising a refusal to accept said first data packet.

28. The system of claim 27, wherein the receiver receives a clear-to-send (CTS) from said intermediate node, said CTS comprising a refusal to accept said first data packet.

29. The system of claim 27, wherein the receiver receives, via a MAC-layer protocol, a transmission from said intermediate node, said transmission comprising a refusal to accept said first data packet.

30. The system of claim 27, wherein the receiver receives an acknowledgement (ACK) from said intermediate node, said ACK comprising a refusal to accept said first data packet.

31. The system of claim 27, wherein the receiver receives a clear-to-send (CTS) from said intermediate node, said CTS comprising a refusal to accept a plurality of said data packets.

32. The system of claim 27, wherein the transmitter delays transmission of said first data packet until receipt of said CTS.

33. The system of claim 27 wherein the receiver receives a transmission from said intermediate node, said transmission comprising information that said intermediate node does not possess routing information corresponding to said destination node.

34. The system of claim 27 wherein the receiver receives a transmission from said intermediate node, said transmission comprising information that said intermediate node cannot accept the packet due to traffic shaping rules.

35. The system of claim 27 wherein the receiver receives a transmission from said intermediate node, said transmission comprising a refusal to accept said first data packet, and comprising information that said intermediate node may be able to accept the packet at a later time.

36. The method of claim 35 wherein the transmitter waits for a given period of time; and transmits, to said intermediate node, a second RTS corresponding to said data packet.

37. The system of claim 27,wherein the transmitter transmits a second data packet to a second intermediate node, said second data packet comprising an encapsulation of said first data packet.

38. The system of claim 27,wherein the transmitter transmits a second data packet to a second intermediate node, said second data packet comprising said first data packet and a source route, said source route corresponding to said destination node, and said source route not comprising said first intermediate node.

39. The system of claim 24 wherein the receiver receives a data packet, said data packet comprising information corresponding to a destination node and information corresponding to given terms of service.

40. The system of claim 39, wherein the processor determines said terms of service are below a given threshold, and the transmitter, in response to said determination, transmits a NAK-squelch corresponding to said data packet.

41. The system of claim 39, wherein the transmitter transmits an RTS to said intermediate node, said RTS corresponding to said first data packet, said RTS comprising information corresponding to said destination node and said terms of service.

42. The system of claim 41, wherein the receiver receives a transmission from said intermediate node, said transmission comprising a refusal to process said first data packet according to said terms of service.

43. A computer system for incorporating information corresponding to an end-to-end transmission in a data link layer protocol, said system comprising:
a receiver which receives a first data packet, said first data packet comprising information corresponding to a destination node;
a storage element in communication with said receiver which stores said data packet;
a processor in communication with said receiver and said storage element which determines an intermediate node for said first data packet;
and
a transmitter in communication with said processor and said storage element which transmits, to said intermediate node via a data link layer protocol, a portion of said first data packet and information corresponding to said destination node.

44. The method of claim 43, wherein the transmitter transmits, to said intermediate node via a data link layer protocol, the entirety of said first data packet and information corresponding to said destination node.

45. The method of claim 43, further comprising the step of receiving an acknowledgement (ACK), said ACK comprising a refusal to accept said first data packet.

46. The method of claim 43, further comprising the step of receiving an acknowledgement from said second intermediate node, said ACK comprising information that said intermediate node does not possess routing information corresponding to said destination node.
